(19) United States
(12) Patent Application Publication
(10) Pub. No.: US 2003/0061952 A1
(43) Pub. Date: Apr. 3, 2003

(54) Printing machine with image formation on the printing plate

(76) Inventor: Volkmar Schwitzky, Wurzburg (DE)

Correspondence Address: GOODWIN PROCTER & HOAR LLP, 7 BECKER FARM RD, ROSELAND, NJ, 07068, US

(21) Appl. No.: 09/966,508

(22) Filed: Sep. 29, 2001

(51) Int. Cl. B41F 5/16; B41F 5/18

(52) U.S. Cl. 101/181

(57) ABSTRACT

The invention relates to a printing machine in unitized configuration with an imaging system for imaging printing plates.

Task of the invention is to establish a multi-color press with one imaging device and low expenditures.

The task is solved according to the invention in a printing press in unitized configuration with an imaging system for printing plates containing a feeder including infeed, a delivery, at least one impression cylinder, several direct or indirect through a blanket cylinder connected printing form cylinders allocated to one or more impression cylinders, an inking unit or an inking and dampening unit allocated to each printing form cylinder, a device for changing printing plates and a central device for imaging of printing plates and a transport system transporting imaged printing plates to the device for changing printing plates of the individual printing form cylinders.

### FIELD OF INVENTION

The invention relates to a printing machine in unitized configuration with imaging system for printing plates.

### BACKGROUND OF INVENTION

Multi-color printing machines embodied for instance as sheet fed offset presses are known different configurations as satellite presses, tandem (V-) presses and unitized presses.

These machine have at least one impression cylinder, several blanket cylinders, several printing form cylinders and inking and dampening unit cooperating with the printing form cylinders.

It is known to equip these presses also with an imaging system for instance with a process known as the Direct Imaging System. This imaging system is located in the side areas of the printing form cylinder not claimed by the inking and dampening unit. In this system the digitally available printing image information is transferred by an electroerosive process or by laser diodes to the printing plate (see Information, Digitale Drucksysteme, Bundesverband Druck, Wiesbaden I/1994). Further systems for imaging of printing plates with applying, hardening and/or erasing devices were also proposed. These mentioned systems are relatively costly. They have to be allocated to each printing form cylinder of a multi-color press, which causes an extreme expenditure for a multi-color press with for instance 10 printing units.

Another multi-color press with an imaging system for printing plates, consisting of a feeder, a delivery, at least one impression cylinder, several direct or indirect through a blanket cylinder connected printing form cylinders allocated to the impression cylinder or impression cylinders, an inking unit or inking and dampening unit allocated to each printing form cylinder and a device for imaging of printing plates, where a single device for imaging printing plates for more than one printing form cylinder can be allocated to subsequently each printing form cylinder is, known from DE 195 12 420 A2.

This solution is disadvantageous because the imaging is possible only subsequently.

### SUMMARY DESCRIPTION OF INVENTION

Task of the invention is to establish a multi-color press with one imaging device and low expenditures.

The task is solved according to the invention in a printing press in unitized configuration with an imaging system for printing plates containing a feeder including infeed, a delivery, at least one impression cylinder, several direct or indirect through a blanket cylinder connected printing form cylinders allocated to one or more impression cylinders, an inking unit or an inking and dampening unit allocated to each printing form cylinder, a device for changing printing plates and a central device for imaging of printing plates and a transport system transporting imaged printing plates to the device for changing printing plates of the individual printing form cylinders.

### BRIEF DESCRIPTION OF THE DRAWINGS

The invention is described below in greater detail by an embodiment of the invention, by reference being had to the drawing, wherein:

FIG. 1: Printing press with imaging system for printing plates

### DETAILED DESCRIPTION

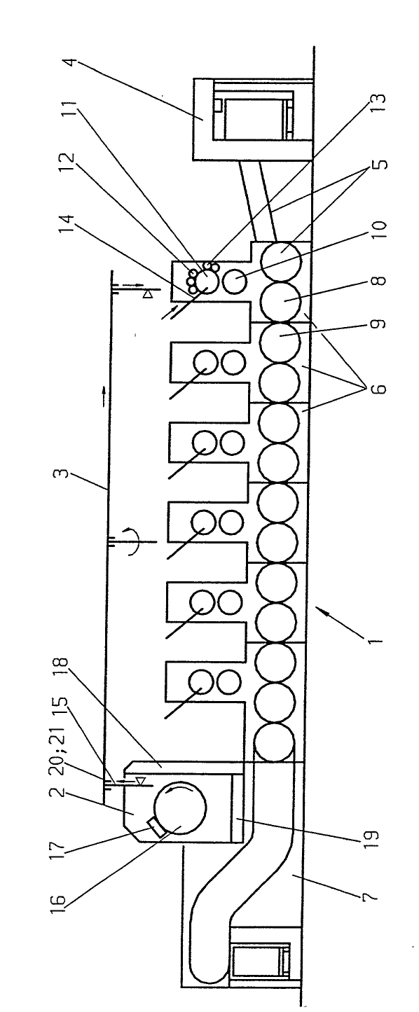

The printing machine 1 in FIG. 1 has a conventional unitized configuration besides the central device for imaging of printing plates 2 and a transport system 3. The printing press 1 has a feeder 4, an infeed 5 and at least on printing unit 6 and a delivery 7. The printing press can also have a multitude of printing units, one or more perfecting units, different coating units and other known additional accessories.

Each printing unit 6 has an impression cylinder 8 and a transfer drum 9 for the sheet travel, an ink carrying blanket cylinder 10 and a printing form cylinder 11 with an inking unit 12 and a dampening unit 13. Each printing form cylinder 11 is equipped with a known device for changing printing plates 14.

The device for changing printing plates 14 supplies the printing plate 15 with accurate register to the printing form cylinder 11, where it is clamped and tensioned. The printing plate 15 has recesses for accurate register, which are corresponding with the registering pins of the printing form cylinder 11. The device for changing printing plates 14 removes also the used printing plate 15 from the printing form cylinder 11 after printing.

The device for imaging of printing plates 2 has an imaging cylinder 16, an imaging head 17, a magazine 18 for un-imaged printing plates, a magazine 19 for used printing plates and a cleaning device for printing plates.

The device for imaging of printing plates 2 contains furthermore a plate punch for punching the recesses for accurate registering of the printing plate and a device for bending the printing plate.

The imaging cylinder 16 has preferably at least twice the diameter of the single sized printing form cylinder 11 in order to image at least two printing plates within one imaging cycle.

The transport system 3 is in its simplest form a manual system, i.e. the imaged printing plates are transported by the press personal from the device for imaging of printing plates 2 to the device for changing printing plates 14.

The transport system 3 can be also an automated system.

The transport system 3 takes end of the printing plate 21 with vertical moveable grippers 20 and transports the printing plate 15 in horizontal direction to the device for changing printing plates 14. The position of the printing plate during transport can be vertical or horizontal. Subsequently the printing plate is rotated if necessary to get the printing image (triangle in FIG. 1) in the right position and transferred to the device for changing printing plates 14.

We claim:

1. Printing machine in unitized configuration with an imaging system for printing plates, containing a feeder including infeed, a delivery, at least one impression cylinder, several direct or indirect through a blanket cylinder connected printing form cylinders allocated to one or more impression cylinders, an inking unit or an inking and dampening unit allocated to each printing form cylinder, a device for changing printing plates and a device for imaging of printing plates whereby the printing machine has a central device for imaging of printing plates and a transport system for transporting the imaged printing plate to the device for changing printing plates of individual printing form cylinders.

2. Printing machine in unitized configuration according to claim 1, whereby imaging cylinder allocated to device for imaging of printing plates has a multiple size of the printing form cylinder.

3. Printing machine in unitized configuration according to claim 1, wherebythe printing plate is transported in vertical position.

4. Printing machine in unitized configuration according to claim 1, wherebythe printing plate is transported in horizontal position.

5. Printing machine in unitized configuration according to claim 1, wherebythe printing plate is supplied with its front edge to the device for changing printing plates of the printing form cylinders.

6. Printing machine in unitized configuration according to claim 1, whereby the transport system is embodied as a manual system.

7. Printing machine in unitized configuration according to claim 1, whereby the transport system is embodied as an automated system.
